(19) United States
(12) Patent Application Publication
(10) Pub. No.: US 2014/0002667 A1
(43) Pub. Date: Jan. 2, 2014

(54) Differential Infrared Imager for Gas Plume Detection

(71) Applicants: Joseph M. Cheben, Boerne, TX (US); Yousheng Zeng, Baton Rouge, LA (US); Jon Morris, Baton Rouge, LA (US); Yanhua Ruan, Baton Rouge, LA (US)

(72) Inventors: Joseph M. Cheben, Boerne, TX (US); Yousheng Zeng, Baton Rouge, LA (US); Jon Morris, Baton Rouge, LA (US); Yanhua Ruan, Baton Rouge, LA (US)

(21) Appl. No.: 14/001,365

(22) PCT Filed: Mar. 12, 2012
(86) PCT No.: PCT/US12/28791

§ 371 Date: Aug. 23, 2013

Related U.S. Application Data
(60) Provisional application No. 61/467,816, filed on Mar. 25, 2011.
(60) Provisional application No. 61/509,909, filed on Jul. 20, 2011.
(60) Provisional application No. 61/540,391, filed on Sep. 28, 2011.

(51) Int. Cl. G01N 21/31

(52) U.S. Cl. CPC G01N 21/3151
USPC 348/164

(57) ABSTRACT

Apparatus, systems, and methods autonomously detect a chemical plume. The system includes an apparatus for splitting a beam of electromagnetic radiation and feeding the split beam to at least two detectors, which are operably connected to a first bandpass filter and a second bandpass filter that passes a wavelength of electromagnetic radiation that is similar in magnitude but offset from the wavelengths passed by the first bandpass filter. The system further comprises an analysis system configured to analyze images from the at least two detectors, a processor, and a non-transitory, computer-readable medium comprising code configured to direct the processor to perform functions. Exemplary functions include comparing a plurality of deterministic features, a plurality of probabilistic features of objects, or both, from the at least two detectors and determining if a difference between the compared images represents a chemical plume.

### CROSS-REFERENCE TO RELATED APPLICATIONS

This application claims priority from U.S. Provisional Application No. 61/467,816, filed on Mar. 25, 2011, entitled Apparatus and Systems for Identifying Hydrocarbon Gas Emissions and Methods Related Thereto; U.S. Provisional Patent Application No. 61/509,909, filed Jul. 20, 2011, entitled Autonomous Detection for Chemical Plumes, both of which are incorporated by reference herein in their entirety; and U.S. Provisional Patent Application No. 61/540,391, filed Sep. 28, 2011, entitled Differential Infrared Imager for Gas Plume Detection, each of which is herein incorporated by reference in its entirety.

### FIELD OF THE DISCLOSURE

The present techniques relate to apparatus and systems for identifying chemical emissions. More particularly, the disclosure is related to autonomous apparatus and systems that scan for and identify chemical emissions in facilities.

### BACKGROUND

This section is intended to introduce various aspects of the art, which may be associated with exemplary embodiments of the present techniques. This discussion is believed to assist in providing a framework to facilitate a better understanding of particular aspects of the present techniques. Accordingly, it should be understood that this section should be read in this light, and not necessarily as admissions of prior art.

Hydrocarbon usage is a fundamental aspect of current civilization. Facilities for the production, processing, transportation, and use of hydrocarbons continue to be built in locations around the world. The efficiency of these plants become increasingly important, as even minor losses of hydrocarbons can add to cost or create issues for regulatory agencies.

Hydrocarbons may be lost or used before sale due to process limitations, process upsets leading to flaring, leaks, and usage of part of the hydrocarbons to fuel the process. While most of these issues can be directly improved by design, leaks can provide a challenge, as they may occur on any number of different process equipment types. For example, leaks can originate from pipe flanges, valves, valve stems, sampling systems, and any number of other locations. As equipment is used and ages, leaks become increasing probable.

Plant conditions may increase the probability of leakage or exacerbate leaks when they form. For example, plants used to generate liquefied natural gas (LNG) use high pressures and cryogenic temperatures, both of which can increase the probability of leaks. The number of LNG liquefaction plants around the world is growing rapidly. As these plants age, there is an increasing potential for hydrocarbon leaks to develop.

Early detection and repair of leaks can be useful in preventing any number of issues, such as increased costs and regulatory issues. Leaks may be detected by operators, for example, by seeing the release, smelling the hydrocarbons, or hearing noise caused by the release. However, most hydrocarbon vapors are not visible to the naked eye. Further, there is often a high level of equipment congestion in plants, which may place a leak point behind another piece of equipment. In addition, hydrocarbons may have a minimal odor and, thus, may not be detected by smell. Detecting a small leak by sound is improbable, as the very high level of ambient noise makes it unlikely that the leak may be heard.

Leak detection systems have been installed in many hydrocarbon facilities. These systems may include combustible gas detectors that monitor the concentration or lower explosive limit (LEL) of hydrocarbon vapors at a particular location, providing a measurement of a hydrocarbon level at a point in an area. An array of point measurement systems may then be used to track a vapor release across the area. However, point detection systems may not detect small releases, such as from small leaks or new leaks, the amount of hydrocarbons released, and the like.

Other leak detection systems have been used to detect hydrocarbons in a line across a plant environment, for example, by directing a light source at one edge of an area towards a spectroscopic detector at another edge of the area. While such systems may be useful for monitoring compliance for regulatory issues, they do not necessary identify a location of a release along the line. Further, they may not detect small releases at all for the same reasons as the point detectors, e.g., the hydrocarbons may be too dilute to detect, or may be blown away from the detection line by the wind.

Thus, depending on the location of a leak and a direction of a gas release relative to conventional gas detectors, leaks may remain undetected for some period of time. This may allow vapor clouds to develop, causing problems in the plant environment.

Systems have been developed to detect releases by imaging areas using hyperspectral cameras, which can directly show an image of a hydrocarbon plume. For example, Hackwell, J. A., et al., “LWIR/MWIR Hyperspectral Sensor for Airborne and Ground-based Remote Sensing,” Proceedings of the SPIE, Imaging Spectroscopy II, M. R. Descour, and J. M. Mooney, Eds., Vol. 2819, pp. 102-107 (1996), discloses an infrared imaging spectrograph which was first used as an airborne sensor in October, 1995. The instrument was named a spatially-enhanced broadband array spectrograph system (SEBASS). The SEBASS system was intended to explore the utility of hyperspectral infrared sensors for remotely identifying solids, liquids, gases, and chemical vapors in a 2 to 14 micrometers spectral region often used to provide a chemical fingerprint. The instrument is an extension of an existing non-imaging spectrograph that used two spherical-faced prisms to operate simultaneously in the atmospheric transmission windows found between 2.0 and 5.2 micrometers (MWIR) and between 7.8 and 13.4 micrometers (LWIR). The SEBASS system was used in March 1996 for a tower-based collection.

The SEBASS system allows the imaging and identification of chemical materials, such as plumes, in an environment. However, it was not used for autonomous identification of chemical releases. Without an autonomous monitoring system, the images have to be manually examined by a person, making fast identification problematic. Further, the complexity of the system itself could make continuous autonomous usage problematic.

In a presentation entitled “The Third Generation LDAR (LDAR3) Lower Fugitive Emissions at a Lower Cost” (presented at the 2006 Environmental Conference of the National Petrochemical & Refiners Association, Sep. 18-19, 2006), Zeng, et al., disclosed an autonomous system for leak identification that used a camera to identify leaks in a particular area of a plant. Any leaks may be automatically recognized by software that processes infrared (IR) video images. In the images, background and noise interference are minimized and likely volatile organic compound (VOC) plumes are isolated using an algorithm. The algorithm determines if an image contains a chemical plume based on a temporal fast Fourier transform (FFT) calculation comparing numerous aligned frames. A chemical plume may generate high frequencies due to flickering characteristics in the atmosphere, yielding high intensity pixels in the processed image. A plume index (PI) is calculated based on the number and intensity of pixels in the processed VOC plume image. If the PI is greater than an experimentally determined threshold value, an action can be triggered, such as an alarm or a video capture for confirmation.

While the LDAR3 system describes a method to use the frequency domain to align video images and remove camera shaking, it does not adequately address complex interferences such as moving equipment, people, vehicles, or steam which can lead to false detections. Accordingly, more accurate plume identification techniques are needed.

### SUMMARY OF THE DISCLOSURE

Provided are apparatus, systems, and methods for autonomously detecting a chemical plume. The apparatus includes a lens, a beam splitter, a first detector, a second detector, a first bandpass filter that passes a wavelength of electromagnetic radiation that is absorbed or emitted by a chemical species and rejects frequencies outside that range, and a second bandpass filter that passes a wavelength of electromagnetic radiation that is similar in magnitude and offset from the wavelengths passed by the first bandpass filter and rejects frequencies outside that range.

The system includes the apparatus, an analysis system configured to analyze images from the first detector and the second detector, a processor, and a non-transitory, computer-readable medium comprising code configured to direct the processor to perform functions. Exemplary functions include: (a) identify a plurality of deterministic features and a plurality of probabilistic features of objects in an image from the first detector; (b) identify a plurality of deterministic features and a plurality of probabilistic features of objects in an image from the second detector; (c) compare (i) the plurality of deterministic features, or the plurality of probabilistic features, or both from the first detector, to (ii) the plurality of deterministic features, or the plurality of probabilistic features, or both from the second detector; and (d) determine if a difference between the compared images represents a chemical plume.

The method for autonomously detecting a chemical plume includes the steps of: (a) splitting a beam of electromagnetic radiation into at least two beams, which are directed to corresponding at least two detectors, (b) obtaining a first plurality of images from a first detector at least at a wavelength of electromagnetic radiation selected to be absorbed or emitted by a chemical species; (c) obtaining a second plurality of images from a second detector at a wavelength of electromagnetic radiation similar in magnitude but offset from the wavelength of the first detector; (d) comparing the first plurality images to the second plurality of images to identify differences in a deterministic feature, changes in a probabilistic feature, or both; and (e) recognizing a chemical plume based, at least in part, on the differences.

### BRIEF DESCRIPTION OF THE DRAWINGS

The advantages of the present techniques are better understood by referring to the following detailed description and the attached drawings:

FIG. 1 is a schematic diagram of a conventional infrared camera.

FIG. 2 is a schematic diagram of an exemplary apparatus for differential Infrared imager.

FIG. 3 is an exemplary infrared spectrograph for propane and background scene due to blackbody radiation.

### DETAILED DESCRIPTION

In the following detailed description section, specific embodiments of the present techniques are described. However, to the extent that the following description is specific to a particular embodiment or a particular use of the present techniques, this is intended to be for exemplary purposes only and simply provides a description of the exemplary embodiments. Accordingly, the techniques are not limited to the specific embodiments described below, but rather, include all alternatives, modifications, and equivalents falling within the true spirit and scope of the appended claims.

At the outset, for ease of reference, certain terms used in this application and their meanings as used in this context are set forth. To the extent a term used herein is not defined below, it should be given the broadest definition persons in the pertinent art have given that term as reflected in at least one printed publication or issued patent. Further, the present techniques are not limited by the usage of the terms shown below, as all equivalents, synonyms, new developments, and terms or techniques that serve the same or a similar purpose are considered to be within the scope of the present claims.

As used herein, a “camera” is a device that can obtain a sequence of two dimensional images or frames (such as video or series of still images) in a variety of spectral domains, including but not limited to visible, infrared, and ultraviolet. In an embodiment, a camera forms a two dimensional image of an area in the infrared spectrum, such as between about 2 to 14 micrometers. In another example, a camera forms a two dimensional image of an area in the ultraviolet spectrum, such as between about 350 nm to 400 nm. Any number of other cameras can be used in the present system, depending on the wavelengths desired. The wavelengths can be selected based on the likely chemical species that may be released from a leak in a facility. In another embodiment, a camera may utilize one or more beam splitters to form multiple two dimensional images of an area. These images may be formed for different infrared spectras.

A “chemical species” is any compound that may be released in a leak, either as a vapor or as a liquid. Examples of chemical species that may be detected using the systems and techniques described herein include both hydrocarbons and other chemical species. Chemical species that may be detected include but are not limited to hydrocarbon vapors released in a cloud in an LNG plant or other facility or oil forming a slick on top of a body of water. Non-hydrocarbon species that may be detected include but are not limited to hydrogen fluoride gas released as a vapor in refinery, chlorine released as a vapor in a water treatment facility, or any number of other liquids or gases. Chemical species may also be deliberately added to a process stream to enhance the detection of a plume using the techniques described herein.

“Electromagnetic radiation,” or EM radiation, included electromagnetic waves or photons that carry energy from a source. EM radiation is often categorized into spectral ranges by its interaction with matter. As used herein, visible light or the visible spectrum includes light that is detectable by a human eye, e.g., from about 400 nanometers (nm) to about 700 nm. Ultraviolet (UV) light, or the UV spectrum, includes light having wavelengths of around 190 nm to about 400 nm. In the UV and visible spectral ranges, chemical substances may absorb energy through electronic transitions in which an electron is promoted from a lower orbital to a higher orbital. Infrared (IR) light, or the IR spectrum, includes light at wavelengths longer than the visible spectrum, but generally lower than the microwave region.

For example, the IR spectrum may include light having a wavelength between about 0.7 and 14 micrometers (μm) in length. At the longer wavelength end of this continuum at about 10 μm to about 14 μm (the far-IR), chemical substances may absorb energy through rotational transitions. At an intermediate wavelength range of about 2.5 μm to about 10 μm (mid-infrared), chemical substances may absorb energy through vibrational transitions. At the lower end of the wavelength range at about 0.7 μm to 2.5 μm (near-IR), chemical substances may absorb energy through vibrational transitions and through similar processes as visible and UV light, e.g., through electronic transitions. Camera images may be formed from electromagnetic radiation in the visible spectrum, IR spectrum, or UV spectrum using a relatively simple detector, such as a charge coupled device (CCD).

As used herein, a “Facility” is a tangible piece of physical equipment through which hydrocarbon fluids are produced from a reservoir, injected into a reservoir, processed, or transported. In its broadest sense, the term facility is applied to any equipment that may be present along the flow path between a reservoir and its delivery outlets. Facilities may comprise production wells, injection wells, well tubulars, wellhead equipment, gathering lines, manifolds, pumps, compressors, separators, surface flow lines, steam generation plants, processing plants, and delivery outlets. Examples of facilities include fields, polymerization plants, refineries, LNG plants, LNG tanker vessels, and regasification plants, among others.

A “hydrocarbon” is an organic compound that primarily includes the elements hydrogen and carbon, although nitrogen, sulphur, oxygen, metals, or any number of other elements may be present in small amounts. As used herein, hydrocarbons generally refer to components found in natural gas, oil, or chemical processing facilities, such as refineries or chemical plants.

As used herein, the term “natural gas” refers to a multi-component gas obtained from a crude oil well (associated gas) and/or from a subterranean gas-bearing formation (non-associated gas). The composition and pressure of natural gas can vary significantly. A typical natural gas stream contains methane (CH₄) as a major component, i.e. greater than 50 mol % of the natural gas stream is methane. The natural gas stream can also contain ethane (C₂H₆), higher molecular weight hydrocarbons (e.g., C₃-C₂₀ hydrocarbons), one or more acid gases (e.g., hydrogen sulfide), or any combination thereof. The natural gas can also contain minor amounts of contaminants such as water, nitrogen, iron sulfide, wax, crude oil, or any combination thereof.

“Substantial” when used in reference to a quantity or amount of a material, or a specific characteristic thereof, refers to an amount that is sufficient to provide an effect that the material or characteristic was intended to provide. The exact degree of deviation allowable may in some cases depend on the specific context.

Provided are apparatus, systems, and methods for autonomously identifying chemical plumes in the air or on a water surface. The technology described herein improves the detection of chemical plumes in hydrocarbon plants, which may help to reduce the probability of leaks remaining undetected for an extended period of time.

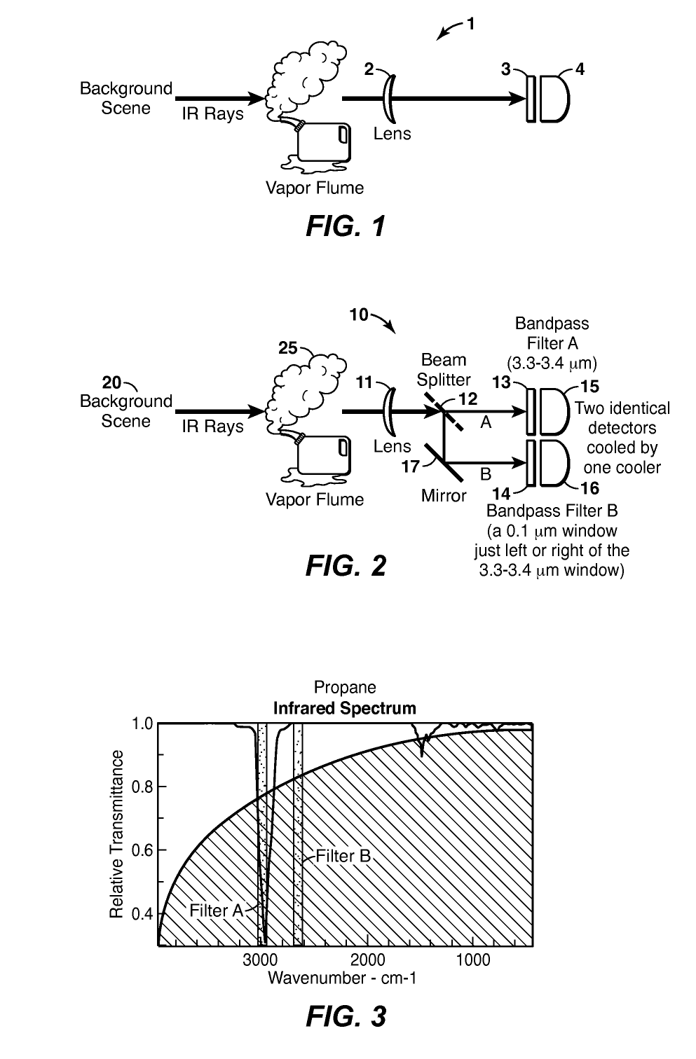

In some embodiments, an infrared imaging camera is used, since many hydrocarbon species absorb at a wavelength in the IR spectrum. Specially designed Infrared (IR) cameras can “see” certain gases that human eyes cannot. Conventional gas detecting IR cameras are commercially available, e.g., GF320 and GF306 manufactured by FLIR Systems, Inc., and EYE-C-GAS manufactured by Opgal. FIG. 1 is a simplified illustration of the working principle of conventional IR cameras. A camera 1 includes a lens 2 to focus an image through a filter 3 onto a sensor 4.

In contrast to conventional IR cameras, a system for autonomously detecting a chemical plume as described herein includes optics, at least one splitter that provide nearly identical images, i.e., electromagnetic radiation beam, to two or more detectors, i.e., sensors. Optics include conventional camera optics, such as lenses, shutters, etc. Preferably, a conventional lens is utilized to focus an image on a splitter.

The splitter is any splitter that can receive the image, i.e., electromagnetic radiation or electromagnetic radiation beam, from the lens and split the electromagnetic radiation beam into two or more beams. In one or more embodiments, the splitter splits the electromagnetic radiation beam, i.e., image, into two or more beams, or three or more beams, or four or more beams, or five or more beams. In one or more embodiments, the splitter functions as a prism, which refracts the electromagnetic radiation beam into its constituent wavelengths. In some embodiments, one beam could be created in the visible spectrum to infuse the detected plume into the visible image for easy human viewing.

In one or more embodiments, the beam splitter is constructed from a commercially available material which has approximately a 50% transmittance rate and a 50% reflection rate. Alternatively, the splitter can have a higher transmittance rate to one detector. For example, a transmittance rate of 60% or 70% or 80% or more can go to one detector while the remaining detectors receive 40%, or 30% or 20% respectively. In alternative embodiments, the splitter has: (a) a high (e.g., greater than 80% or greater than 90% or nearly 100%) transmittance rate in a narrow spectral window, (b) a high (e.g., greater than 80% or greater than 90% or nearly 100%) reflection rate in another spectral window, or (c) combinations of both (a) and (b).

Each detector has a corresponding filter, such as a bandpass filter, which passes electromagnetic radiation wavelengths within a certain range and rejects wavelengths outside the “pass” range. In one or more embodiments, each filter has a narrow transmittance window, such as about 1 μm or about 0.5 μm, or about 0.1 μm. Preferably, the present system utilizes one filter that has a narrow transmittance window that “sees” a chemical plume, i.e., electromagnetic radiation emitted from the chemical species, and a second filter that has a narrow transmittance window that is similar to, but “offset” from, the transmittance window of the first filter. In other words, on a spectrograph, the transmittance window of the second filter is shifted to the left or right of the first filter, which only includes background electromagnetic radiation, i.e., away from electromagnetic radiation reflected from the chemical species. The amount of “offset” varies by application, equipment, and chemical species being detected. Preferably, the “offset” is sufficient to enable the detectors to distinguish between the background and the chemical species.

For example, in a two detector system, beam A passes through bandpass filter A to form an image on the detector. Light beam B passes through bandpass filter B. Filter B also has a narrow transmittance window. However, the window is shifted either to left or right of the Filter A window. FIG. 3 is an exemplary infrared spectrograph for propane to show the bandpass in relation to the IR spectrum. FIG. 3 shows that bandpass filter B is shifted to the right of bandpass filter A but it could also be shifted to the left.

In one or more embodiments, for detection of hydrocarbon vapors, at least one filter has a narrow transmittance window between the wavelength of about 3.3 and about 3.4 μm, which corresponds to the IR absorption bands of most hydrocarbon compounds.

The images sent to each detector may be a single image, a series of still images, or video images. Preferably, the images sent to the two or more detectors are registered so that the images match in spatial alignment pixel by pixel, temporally, or both. Synchronization of images spatially, temporally, or both enable improved analysis capabilities compared to conventional filter wheel apparatus.

The detectors are conventional detectors, i.e., sensors, that detect electromagnetic radiation. The detectors may be in any configurations. The detectors can receive the electromagnetic radiation beam from the splitter directly or from optional mirrors which direct the beams. Preferably, the detectors are identical to add in image processing and analysis. In one or more embodiments, the detectors are cooled and may be cooled by a single cooler. An exemplary detector for use in detecting hydrocarbon species is a cooled mid-wave IR detector.

In exemplary systems with two detectors, the splitter creates two images, image A and image B, the images can be filtered so that one detector may have the background and the gas plume, image A, and the second detector may have an identical background but no gas plume. In this embodiment, subtracting image B from image A yields a differential image, i.e., “image C”, that contains nothing but the gas plume.

Without being limited by theory, it is believed to be possible that the intensity of the background images in the two detectors may vary slightly due to slight variations in background blackbody radiation, transmittance of optical components, or bandpass filter wavelengths, these differences may be relatively small and relatively constant. Preferably, these slight differences can be accounted for as part of the signal processing when image B is subtracted from image A.

The system enhances gas detection capability in general and is particularly suited for autonomous gas plume detection. With current IR gas detection cameras, moving objects in the scene, such as people walking, vehicles moving, birds flying, steam plumes, etc., and changes in background, such as ambient thermal energy level change due to cloud movement, the angle of the sun, camera shaking, etc., make it difficult to observe small gas plumes when conventional IR cameras are manually operated. If such conventional IR cameras could be used with autonomous leak detection systems, they may require very sophisticated algorithms to distinguish plumes from other changes in the scene and other interference with plume detection.

In contrast to conventional IR cameras, present embodiments with at least two detectors shows moving objects and changes in background intensity are in image A and image B with the same spatial and temporal resolution. Subtracting image B from image A eliminates these interferences and provides an image of the target plume at a high frame rate suitable for autonomous detection. Thus, the present system greatly simplifies plume recognition algorithms and significantly reduces false alarm rate.

In one or more embodiments, the signal processing required to produce a differential images, e.g., image C as described above, along with any necessary adjustments for intensity or registration could be implemented in the firmware of a DIR camera, thereby simplifying the overall system and significantly reducing the resources required for deployment of autonomous leak surveillance systems.

Some conventional IR cameras use frame-by-frame differencing and try to achieve a differential image. For example, FLIR refers to a High Sensitivity Mode, and Opgal refers to an Enhanced Mode, which attempt to make a chemical plume more visible to the human eye. However, in the frame by frame differencing method there are temporal and spatial differences introduced which make the scene unstable and unsuitable for autonomous detection.

For example, spatial differences introduced by slight movements of the camera produces a shaky image. Changes in background intensity may also be magnified in these frame differencing modes producing a similarly unstable video. Similar difficulties are encountered due to temporal differences created by fast moving objects in a scene. These difficulties cannot be resolved by current imaging devices such as FTIR based hyper-spectral imagers, scanning based multi-spectral imagers, or filter wheel based multi-band imagers.

Unlike conventional frame-by-frame differencing as described above, the present system overcomes these problems because image A and image B are both spatially and temporally synchronized. Thus, the present technology is applicable to both autonomous systems and manually operated IR cameras.

FIG. 2 is a schematic diagram of an exemplary system for automated gas detection and response scheme. Referring to FIG. 2, a system 10 includes a lens 11, a beam splitter 12, a first filter 13, a second filter 14, a first detector 15, a second detector 16, and a mirror 17.

The backgrounds 20 observed in the first and second detectors represent the composite thermal IR radiation of solid or liquid objects in the scene. Unlike the narrow absorption bands of most hydrocarbon gases, this thermal radiation represents a wide band in the mid-wave IR spectrum, resembling blackbody radiation (loosely represented as the massive band overlaying on the Propane spectrum in FIG. 3). Since the first and second filters 13 and 14 are narrow they are essentially the same with regard to the wide band represented by the background. They are however highly selective with regard to hydrocarbons with the first detector 15 observing the gas plume 25 while second detector 16 sees no plume.

In alternative embodiments, the second filter and second detector for beam B could have a separate cooler and be arranged in a 90 degree angle with respect to beam A in place of the mirror, thereby eliminating the mirror. Also, the second detector could be an uncooled detector because the detector is not used for gas detection and the sensitivity requirement is lower.

Without being limited by theory, a benefit of using two filters of similar magnitude, but offset in wavelength, provides similar amount of energy to each of the two detectors. If one of the detectors is not filtered, it may receive significantly greater IR energy, such as by about 10-50 times greater than the filtered detector.

In one or more alternative embodiments, a system for autonomously detecting a chemical plume includes two detectors, but only one detector will have a filter. Preferably, the second detector is not cooled. In these embodiments, any differences in the background scene identified by the each detector are processed to reduce the possibility of false alarm.

Many analysis techniques may be utilized to determine whether a chemical species is detected. For example, when a “differential” image is created as described above, any difference between image A and Image B may be considered a “positive” reading, i.e., indication of a chemical species. Analysis of the differential image may be as simple as determining whether “image C” indicates any difference between image A and image B.

In one or more embodiments, additional analysis techniques may be utilized. System components and methods for performing the image analysis are described herein and further described in U.S. Provisional Application No. 61/509,909, filed Jul. 20, 2011, and U.S. Provisional Application No. 61/467,816, filed Mar. 25, 2011, each of which are herein incorporated by reference in their entirety.

Such analysis techniques use a software algorithm to analyze the images to distinguish chemical plumes from other features in a scene to decrease a probability of false alarms. The software algorithm distinguishes the hydrocarbon vapors from other ambient factors such as water flows, steam plumes, furnace off gases, vehicles, persons, wildlife, and the like. The chemical plumes may be identified by deterministic features, statistical features, and auxiliary features, or any combinations thereof. The image may be a grayscale image, in which the difference in contrast is used to identify features.

As used herein, deterministic features include various features of a chemical plume, such as geometric features, e.g., size and shape of the chemical plume, among others, and kinematic features, such as motion constraints, among others. Statistical features include joint temporal features, such as the overlap of an image of a chemical plume in a frame with the image of the chemical plume in previous frames. Auxiliary features include such features as a comparison of the motion of the chemical plume with expected wind direction, with visible video images of a plant, and the like.

In some embodiments, a camera is mounted on a poll and can be moved, such as panning and tilting, under the control of a system. Several cameras may be positioned around the perimeter of the plant to give 100% coverage of the facility. This autonomous detection system can provide plant surveillance to be performed on a continuous basis. In some embodiments, the overall system cost may be kept low while keeping the false alarm rate low and still being able to detect small or early hydrocarbon leaks, e.g., plumes with about 20% LEL at a distance of 150 meters subject to environmental conditions.

The detection system can be used in any facility that has hydrocarbons, or other detectable chemical species, present. Examples of such facilities include LNG plants, oil and gas wellhead operations, off shore platforms, transport pipelines, ships, trucks, refineries, and chemical plants. As noted, the chemical plume may be a hydrocarbon or oil slick on a surface of water, such as around an offshore platform, tanker, off-loading platform, and the like.

If a positive identification of the leak and chemical plume is made, the system can locate the leak and activate an alarm, alerting an operator to send a response team to the site of the leak. The response team can confirm the presence of the leak and effectuate repairs. In some embodiments, the hydrocarbon leak may be shown as a false color image for easier operator interpretation. Further, the system may have zoom capability to assist the operator when doing a leak investigation in manual mode.

The system can continue monitoring the facility 24 hours a day, seven days a week, and 365 days per year, i.e., with minimal downtime. Downtime may mainly be the result of performing routine maintenance on the system, and may be compensated for by redundancy, e.g., directing other cameras at an area whose cameras are being serviced.

In some embodiments, the system can be configured to work over a broad temperature range, including cold temperatures and warm, such as a hot, tropical or desert environment or a cold, arctic environment. Further, the system may be adapted to function in the day or night and at temperatures ranging from about minus 10° C. to 50° C. The system may also be configured to operate under other environmental interferences, such as in fog, rain, or sandstorms. In various embodiments, the system may detect hydrocarbons, such as methane, ethane, or propane, among others. The system may also be configured to detect other chemical species which can be imaged.

The camera may be pole mounted and, as mentioned, have an automatic pan and tilt capability and 360 degree coverage. In some embodiments, the camera may be able to be operated in both the automatic and manual modes. Thus, in the event of an alarm, an operator may be able to take control of the camera to do further investigation.

The present systems may utilize ambient energy for the detection, but may also utilize artificial illumination sources. In some embodiments, an electromagnetic radiation source, e.g., light source, may be used to illuminate the environment. For example, an IR laser may be used to illuminate an area of interest for leak confirmation. The light source may be useful in conditions in which the contrast between a plume and the background may not be sufficient to distinguish the chemical species. The light source may be powered, activated, or moved using a light source control in communication with the present system.

The autonomous detection system is not limited to the detection of chemical plumes, but may also provide other functionality. For example, in an embodiment, the autonomous detection system may be used to monitor specific equipment, such as furnaces, reactors, compressors, and the like, looking for such problems as hot spots, maldistribution, hot motors, and the like. Further, the autonomous detection system may provide fence-line monitoring, for security purposes, and monitoring of fugitive emissions from the equipment in the environment.

The detection and confirmation of plumes may be enhanced by meteorological measurements collected by a meteorological monitor. The meteorological monitor may collect data on environmental conditions such as wind speed, temperature, precipitation, atmospheric haze, and the like. This data may then be used in embodiments to confirm that a detected plume is consistent with the collected data.

Deterministic features may be analyzed. This may include both spatial and kinematic features, among others. For example, the analysis may determine geometric features, including the shape of a chemical plume or the size of a chemical plume. The analysis may also determine shape constraints such as aspect ratio, disperseness (e.g., the thickness of the plume as a function of distance), convexity, and histogram of orientation gradient (HOG) of contour, among others. These features serve as constraints and provide a pre-screening of the potential objects.

Kinematic or motion features may be part of the analysis, such as determining that a plume is constantly moving, but that the motion is restricted to a constrained area, as may be expected by a plume originating from a leak. Kinematic features can include size constraints of a plume, such as a minimal and maximal size through a sequence of images. The kinematic features can be used to filter out most rigid body interferences.

Probabilistic features of the plume can be analyzed. For example, a probabilistic feature can include a spatial pattern of the chemical plume, a temporal pattern of the chemical plume, or any number of other features. The analysis may include joint spatial and temporal analyses such as a fast dynamic texture algorithm. In the probabilistic analysis a statistical model described by two types of equations, e.g., evolution equations and observation equations, which respectively model the way the intrinsic state evolves with time and the way the intrinsic state projects to image pixels, may be fitted to the segmented pixel data. Parameters can be estimated by matrices. Other probabilistic analysis techniques may also be used, such as principal component analysis (PCA). In PCA, a determination of the variables causing changes to a plume is made, such as a statistical comparison of wind speed and direction with changes seen in plumes.

Images visible to the human eye can be compared to the plume identified using the non-visible images, such as images in the IR spectrum. For example, the visible images may be used to differentiate organic vapor plumes and water steam. Generally, organic plumes may be dark in the non-visible images and not very visible in the visible images. In contrast, a steam plume may be bright in the non-visible images, due to emitted heat, and visible in the visible images. In addition to improving the detection, the visible images may be used to locate the leak in the plant environment, for example, by comparing a registered image from camera in the infrared spectrum with an overlapping image from a camera in the visible spectrum.

The gas plume detection can also be improved or confirmed by using data from meteorological monitor. For example, the calculated motion of the plume may be compared with the wind direction, such as in a PCA algorithm. If the motion of the plume is inconsistent with the wind direction, the plume identification may be incorrect.

A number of variations may be used in embodiments to improve the reliability, ease of use, or ease of implementation of the autonomous detection system. In an embodiment, leak modeling results, leak detection criteria, camera and lens characteristics, and algorithm requirements, may be combined to form deployment reference charts for setting up the autonomous detection system.

The detection reliability may also be improved by utilizing chemical markers in various hydrocarbon streams. The chemical markers may be substances added to increase an absorbance or emission at a particular wavelength. Such markers may make the use of other detection techniques more useful. For example, fluorescent chemicals may be added to a hydrocarbon stream in very small amounts, such as a few parts-per-million, as these compounds often have a high quantum yield, which is the number of photons emitted, divided by the number of photons absorbed. As the wavelength of light emitted may not overlap with natural sources, the identification of a plume from the fluorescence may be straightforward.

The autonomous detection system is not limited to pole mounted cameras. In embodiments, the cameras may be pole mounted, attached to autonomous mobile platforms, placed on conveniently located towers, or suspended from cables or balloons. The autonomous detection system may also be integrated into mobile robots, which are either autonomous or steered by an operator.

In one or more embodiments, the system may include multiple detectors with a subset of the detectors being associated with a bandpass filter. For example, a system for autonomously detecting a chemical plume may comprise: a lens, at least one beam splitter, which is configured to receive a beam from the lens and divide the beam into a first beam and a second beam; a first detector, which is configured to receive at least a portion of the first beam from the splitter and a second detector, which is configured to receive at least a portion of the second beam from the splitter. The system may include a first bandpass filter, which is disposed along the first beam's path between the first detector and one of the at least one beam splitter, that passes a wavelength of electromagnetic radiation (e.g., at least a portion of the first beam) that is absorbed or emitted by a chemical species and rejects frequencies outside that range. The second detector may receive the second beam. In this configuration, the detected image from the first beam may be superimposed or combined with the detected image from the second beam to highlight certain wavelengths.

One or more embodiments are further described in the following paragraphs:

1. An system for autonomously detecting a chemical plume comprising: a lens, at least one beam splitter, which is configured to receive a beam from the lens and divide the beam into a first beam and a second beam; a first detector, which is configured to receive at least a portion of the first beam from the splitter
a second detector, which is configured to receive at least a portion of the second beam from the splitter, a first bandpass filter, which is disposed along the first beam's path between the first detector and one of the at least one beam splitter, that passes a wavelength of electromagnetic radiation (e.g., at least a portion of the first beam) that is absorbed or emitted by a chemical species and rejects frequencies outside that range, and a second bandpass filter, which is disposed along the second beam's path between the second detector and one of the at least one beam splitter, that passes a wavelength of electromagnetic radiation that is offset from wavelength passed by the first bandpass filter (and may be similar magnitude to the amount of energy passed to the first detector) and rejects frequencies outside that range.
2. The system for autonomously detecting a chemical plume of paragraph 1 further comprising: an analysis system configured to analyze images from the first detector and the second detector.
3. The system for autonomously detecting a chemical plume of paragraph 2, further comprising: a processor; and a non-transitory, computer-readable medium comprising code configured to direct the processor to: (a) identify a plurality of deterministic features and a plurality of probabilistic features of objects in an image from the first detector; (b) identify a plurality of deterministic features and a plurality of probabilistic features of objects in an image from the second detector; (c) compare (i) the plurality of deterministic features, or the plurality of probabilistic features, or both from the first detector, to (ii) the plurality of deterministic features, or the plurality of probabilistic features, or both from the second detector; and (d) determine if a difference between the compared images represents a chemical plume.
4. The system for autonomously detecting a chemical plume of any one of paragraphs 1 to 3, wherein the first band pass filter only permits the passage of electromagnetic radiation.
5. The system for autonomously detecting a chemical plume of any one of paragraphs 1 to 4, wherein the wavelength of electromagnetic radiation is in the infrared wavelength range.
6. The system for autonomously detecting a chemical plume of any one of paragraphs 1 to 4, wherein the wavelength of electromagnetic radiation is between about 3.1 μm and 3.6 μm.
7. The system for autonomously detecting a chemical plume of any one of paragraphs 1 to 4, wherein the wavelength of electromagnetic radiation is in the ultraviolet wavelength range.
8. The system for autonomously detecting a chemical plume of any one of paragraphs 1 to 4, wherein the wavelength of electromagnetic radiation is in the visible wavelength range.
9. The system for autonomously detecting a chemical plume of any one of paragraphs 3 to 8, wherein a deterministic feature comprises a geometric feature of the chemical plume.
10. The system for autonomously detecting a chemical plume of paragraph 9, wherein the geometric feature comprises a size of the chemical plume, a shape of the chemical plume, an edge of the chemical plume, or any combinations thereof
11. The system for autonomously detecting a chemical plume of any one of paragraphs 3 to 10, wherein a probabilistic feature comprises a kinematic feature of the chemical plume.
12. The system for autonomously detecting a chemical plume of paragraph 11, wherein the kinematic feature comprises a motion of the chemical plume, a change in size of the chemical plume, a shape of the chemical plume, or a location of the chemical plume, or any combinations thereof.
13. The system for autonomously detecting a chemical plume of any one of paragraphs 3 to 12, wherein a probabilistic feature comprises a spatial pattern of the chemical plume, or a temporal pattern of the chemical plume, or both.
14. The system for autonomously detecting a chemical plume of any one of paragraphs 2 to 13, further comprising a distributed control system configured to accept an alarm signal from the analysis system.
15. The system for autonomously detecting a chemical plume of any one of paragraphs 2 to 14, further comprising a human machine interface configured to aim the lens at a location.
16. The system for autonomously detecting a chemical plume of any one of paragraphs 2 to 15, further comprising a meteorological measurement system configured to collect data on meteorological conditions.
17. The system for autonomously detecting a chemical plume of paragraph 16, wherein the meteorological conditions comprise a humidity measurement, a temperature measurement, an insolation measurement, or any combinations thereof.
18. The system for autonomously detecting a chemical plume of any one of paragraphs 1 to 17, wherein the chemical species comprises a hydrocarbon.
19. The system for autonomously detecting a chemical plume of any one of paragraphs 1 to 18, wherein the chemical species comprises methane, ethane, ethylene, propane, propylene, or any combinations thereof.
20. The system for autonomously detecting a chemical plume of any one of paragraphs 1 to 19, wherein the chemical species is a liquid hydrocarbon forming a plume on the surface of a body of water.
21. A method for autonomously detecting a chemical plume comprising the steps of: splitting a beam of electromagnetic radiation into at least two beams, which are directed to corresponding at least two detectors, obtaining a first plurality of images from a first detector at least at a wavelength of electromagnetic radiation selected to be absorbed or emitted by a chemical species; obtaining a second plurality of images from a second detector at a wavelength of electromagnetic radiation offset from the wavelength of the first detector; comparing the first plurality images to the second plurality of images to identify differences in a deterministic feature, changes in a probabilistic feature, or both; and recognizing a chemical plume based, at least in part, on the differences.
22. The method of autonomously detecting a chemical plume of paragraph 21, further comprising the steps of: illuminating an area with an illumination source at least at the wavelength of electromagnetic radiation selected to be absorbed by the chemical species; and obtaining a plurality of images from a detector from the sample space.
23. The method of autonomously detecting a chemical plume of paragraph 21 or 22, further comprising the step of, if a chemical plume is recognized in the plurality of images from the detection camera, sending a message to a remote location.
24. The method of autonomously detecting a chemical plume of any one of paragraphs 21 to 23, wherein analyzing the plurality of images comprises reducing the first and second plurality of images to numerical data, wherein the numerical data comprises a numerical table of frame-to-frame comparisons of frames from the first and second plurality of images.
25. The method of autonomously detecting a chemical plume of paragraph 24, further comprising the step of training a neural network to recognize the chemical plume from the numerical table.

While the present techniques may be susceptible to various modifications and alternative forms, the embodiments discussed above have been shown only by way of example. However, it should again be understood that the techniques is not intended to be limited to the particular embodiments disclosed herein. Indeed, the present techniques include all alternatives, modifications, and equivalents falling within the true spirit and scope of the appended claims.

1. An system for autonomously detecting a chemical plume comprising:
a lens,
a first detector,
a second detector,
a first bandpass filter that passes a wavelength of electromagnetic radiation that is absorbed or emitted by a chemical species and rejects frequencies outside that range, and
a second bandpass filter that passes a wavelength of electromagnetic radiation that is similar in magnitude and offset from wavelength passed by the first bandpass filter and rejects frequencies outside that range.
at least one beam splitter configured to split a beam passing through the lens into at least two beams wherein a first beam sasses through the first bandpass filter to the first detector and a second beam passes through the second bandpass filter to the second detector.

2. The system for autonomously detecting a chemical plume of claim 1 further comprising:
an analysis system configured to analyze images from the first detector and the second detector.

3. The system for autonomously detecting a chemical plume of claim 2, further comprising:
a processor; and
a non-transitory, computer-readable medium comprising code configured to direct the processor to:
(a) identify a plurality of deterministic features and a plurality of probabilistic features of objects in an image from the first detector;
(b) identify a plurality of deterministic features and a plurality of probabilistic features of objects in an image from the second detector;
(c) compare (i) the plurality of deterministic features, or the plurality of probabilistic features, or both from the first detector, to (ii) the plurality of deterministic features, or the plurality of probabilistic features, or both from the second detector; and
(d) determine if a difference between the compared images represents a chemical plume.

4. The system for autonomously detecting a chemical plume of claim 1, wherein the first band pass filter only permits the passage of electromagnetic radiation.

5. The system for autonomously detecting a chemical plume of claim 1, wherein the wavelength of electromagnetic radiation is in the infrared wavelength range.

6. The system for autonomously detecting a chemical plume of claim 1, wherein the wavelength of electromagnetic radiation is between about 3.1 μm and 3.6 μm.

7. The system for autonomously detecting a chemical plume of claim 1, wherein the wavelength of electromagnetic radiation is in the ultraviolet wavelength range.

8. The system for autonomously detecting a chemical plume of claim 1, wherein the wavelength of electromagnetic radiation is in the visible wavelength range.

9. The system for autonomously detecting a chemical plume of claim 3, wherein a deterministic feature comprises a geometric feature of the chemical plume.

10. The system for autonomously detecting a chemical plume of claim 9, wherein the geometric feature comprises a size of the chemical plume, a shape of the chemical plume, an edge of the chemical plume, or any combinations thereof.

11. The system for autonomously detecting a chemical plume of claim 3, wherein a probabilistic feature comprises a kinematic feature of the chemical plume.

12. The system for autonomously detecting a chemical plume of claim 11, wherein the kinematic feature comprises a motion of the chemical plume, a change in size of the chemical plume, a shape of the chemical plume, or a location of the chemical plume, or any combinations thereof.

13. The system for autonomously detecting a chemical plume of claim 3, wherein a probabilistic feature comprises a spatial pattern of the chemical plume, or a temporal pattern of the chemical plume, or both.

14. The system for autonomously detecting a chemical plume of claim 2, further comprising a distributed control system configured to accept an alarm signal from the analysis system.

15. The system for autonomously detecting a chemical plume of claim 2, further comprising a human machine interface configured to aim the lens at a location.

16. The system for autonomously detecting a chemical plume of claim 2, further comprising a meteorological measurement system configured to collect data on meteorological conditions.

17. The system for autonomously detecting a chemical plume of claim 16, wherein the meteorological conditions comprise a humidity measurement, a temperature measurement, an insolation measurement, or any combinations thereof.

18. The system for autonomously detecting a chemical plume of claim 1, wherein the chemical species comprises a hydrocarbon.

19. The system for autonomously detecting a chemical plume of claim 1, wherein the chemical species comprises methane, ethane, ethylene, propane, propylene, or any combinations thereof.

20. The system for autonomously detecting a chemical plume of claim 1, wherein the chemical species is a liquid hydrocarbon forming a plume on the surface of a body of water.

21. A method for autonomously detecting a chemical plume comprising the steps of:
splitting a beam of electromagnetic radiation into at least two beams, which are directed to corresponding at least two detectors,
obtaining a first plurality of images from a first detector at least at a wavelength of electromagnetic radiation selected to be absorbed or emitted by a chemical species;
obtaining a second plurality of images from a second detector at a wavelength of electromagnetic radiation offset from the wavelength of the first detector;
comparing the first plurality images to the second plurality of images to identify differences in a deterministic feature, changes in a probabilistic feature, or both; and
recognizing a chemical plume based, at least in part, on the differences.

22. The method of autonomously detecting a chemical plume of claim 21, further comprising the steps of:
illuminating an area with an illumination source at least at the wavelength of electromagnetic radiation selected to be absorbed by the chemical species; and
obtaining a plurality of images from a detector from the sample space.

23. The method of autonomously detecting a chemical plume of claim 21, further comprising the step of, if a chemical plume is recognized in the plurality of images from the detection camera, sending a message to a remote location.

24. The method of autonomously detecting a chemical plume of claim 21, wherein analyzing the plurality of images comprises reducing the first and second plurality of images to numerical data, wherein the numerical data comprises a numerical table of frame-to-frame comparisons of frames from the first and second plurality of images.

25. The method of autonomously detecting a chemical plume of claim 24, further comprising the step of training a neural network to recognize the chemical plume from the numerical table.
